(19) United States
(12) Patent Application Publication
(10) Pub. No.: US 2009/0109857 A1
(43) Pub. Date: Apr. 30, 2009

(54) Resource connection monitor utility

(75) Inventors: Jeromy S. Statia, Duvall, WA (US); Christopher J. Engdahl, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/980,865

(22) Filed: Oct. 31, 2007

(51) Int. Cl. G06F 11/00

(52) U.S. Cl. 370/241

(57) ABSTRACT

A connection monitor utility may monitor the availability of various resources, display a status, and provide various optimization functions for each resource. Performance data may be collected and displayed, and the performance data may be used to optimize, troubleshoot, and notify administrators or users for each connection. Some embodiments may store optimized parameters for connections from different locations. In one use model, the monitor utility may be used with a secure connection to a private network to provide visual feedback of connectivity to various resources and simple optimization of the connections.

### BACKGROUND

Many computers that are connected to a network may connect to various resources across the network. For example, printers, file servers, media players, and other computers may be accessible through a local area network. When a network has access to the Internet, many other computers and devices may also be available, including websites, web hosted services, as well as a plethora of other devices. In many cases, the performance of a connection to a resource may be improved, changed, or optimized by adjusting various settings.

### SUMMARY

A connection monitor utility may monitor the availability of various resources, display a status, and provide various optimization functions for each resource. Performance data may be collected and displayed, and the performance data may be used to optimize, troubleshoot, and notify administrators or users for each connection. Some embodiments may store optimized parameters for connections from different locations. In one use model, the monitor utility may be used with a secure connection to a private network to provide visual feedback of connectivity to various resources and simple optimization of the connections.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a resource connection monitor.

FIG. 2 is a flowchart illustration of an embodiment showing a method for monitoring resource connections.

FIG. 3 is a flowchart illustration of an embodiment showing a method for optimizing a resource connection.

### DETAILED DESCRIPTION

Connections may be monitored for various resources available over a network for a client device. Each resource may be periodically tested to determine if the resource is available and to assess the level of service available from the resource. In some situations, various connection parameters may be optimized based on data collected about the level of service, and those optimized parameters may be saved for later recall. Some such embodiments may also have various sets of configuration parameters for use in different physical locations or other situations.

Connections to various resources may be monitored and summary statistics of the connections may be displayed in a user interface. The user interface may contain summary indicators of the resource availability as well as an input mechanism so that a user may select individual resources or groups of resources to optimize connections to those resources. In many embodiments, the user interface may be a gadget or other application that may run in parallel with other applications on a client device.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

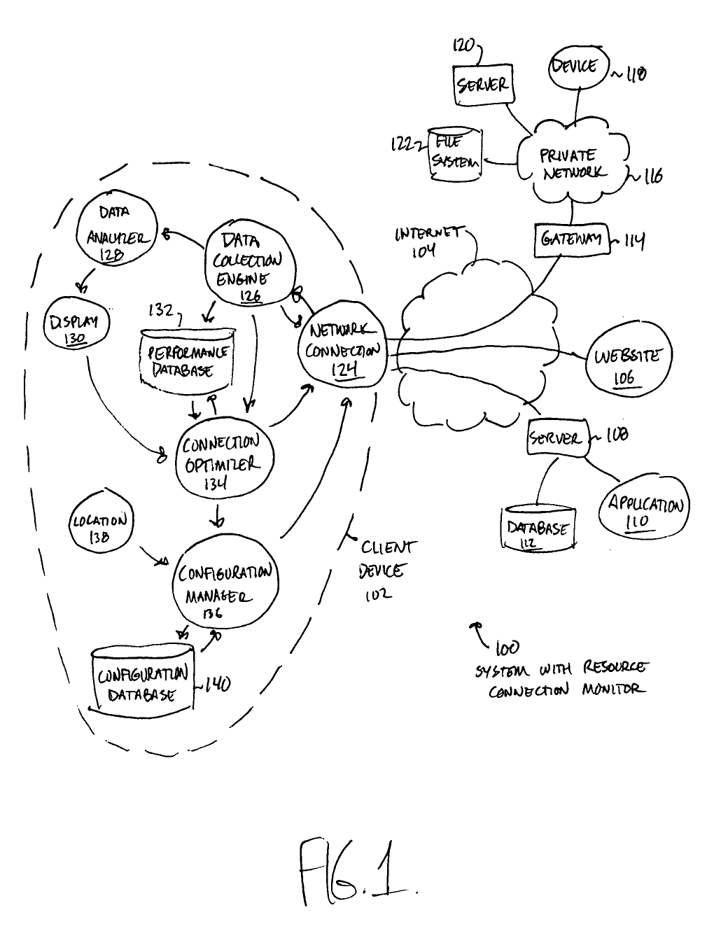

FIG. 1 is a diagram of an embodiment 100 showing a network with a client device that has a resource connection monitor. Embodiment 100 is a simplified example used to highlight various characteristics, features, and uses of a resource connection monitor.

The diagram of FIG. 1 illustrates functional components of a system and may not correspond directly with a hardware or software component of a system. In some cases, a component may be a hardware component, a software component, or a combination of hardware and software. Hardware components may include general purpose components adaptable to perform many different tasks or specially designed components that may be optimized to perform a very specific function. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various functions described.

Embodiment 100 is an example of how a resource monitor may be used as well as an example of the functional components of a resource monitor.

A client device 102 may have a resource monitor that may monitor various resources over a connection to the Internet 104 or other network. In many cases, a client device 102 may be connected to a local area network and may have access to the Internet 104 or other network through a gateway or other connection point. While the client device 102 is illustrated as being connected to the Internet 104, other embodiments may be connected to a local area network, a wide area network, or any other network including hardwired networks and wireless networks.

The resource monitor on the client 102 may monitor the availability of various resources. In some cases, the availability of the resource may include various network performance considerations as well as the performance of the resource itself. For example, the availability of a website 106 may include the bandwidth of the network connection, the routing time and bandwidth through the Internet 104, the bandwidth of the connection from the Internet 104 to the website 106, as well as the response time and performance of the website 106 itself.

The resource monitor may make one or more different types of performance measurements to determine the status of a resource. In a simple example, a resource monitor may execute a ping command against the website 106 to determine if the website is responding as well as estimate the round trip communication time between the resource monitor and the website 106. By knowing that the website is responding to a ping, the resource monitor may determine that the website is operational. The round trip communication time may be used to evaluate the overall performance of the network elements that make up a connection.

In some embodiments, a test query may be performed against the website 106 to exercise various portions of the website. Such queries may be used to generate performance parameters for the resource itself, as opposed to or in addition to performance parameters relating to the network connection alone. For example, a query may be transmitted that exercised the website's access of a database or if a particular feature of the website is operational. In some cases, a network monitor may perform a call to an application programming interface (API), remote procedure call (RPC), or other programming interface for a remote service provided through the website 106. Such queries may be able to generate various performance parameters that relate to the ability of the website 106 to respond to queries.

For example, a test query may exercise a database call used by the website 106 to generate a webpage. The test query may determine that the website 106 has an unusually large delay in responding to database queries. Even if the network connection was very fast, the overall response of the resource may be degraded because of the website performance.

The resource monitor may take one or more performance measurements for a given resource and create a summary statistic or indicator that may be displayed for a user. The summary statistic may take into account one or more parameters to give an indicator of the resource's availability or predicted performance. In the example above, a website 106 may be queried using a ping command as well as a test query that may exercise a database used by the website 106. By combining the results of the ping command and the test query, a summary statistic may be generated that shows the resource availability. If the results of the ping command were satisfactory yet the results of the test query were poor, the resource availability may be listed as poor. The poor availability may be due to the performance of the resource itself.

In a different situation, a ping command may experience a very long latency or round trip communication time while a test query to the website 106 may be satisfactory. Such a situation may result in a poor resource availability, but the availability may be changed by optimizing various network connection parameters.

A resource monitor may operate by performing various tests against resources that may include at least some measure of the availability of the resource and may also include some measure of network connectivity.

A resource monitor may monitor various servers 108 that may be accessible through the Internet 104 or other network. In some cases, a resource may be the server 108 or may be various applications 110 or services that are operable on the server 108. In some cases, a server 108 may provide access to a database 112 through the Internet 104 to the client device 102.

Similarly, a client device 102 may have access to various devices, servers, databases, services, and applications that are available through a gateway 114 and connected to a private network 116. Such resources may include various devices 118 that may include output devices such as printers, optical disk writers, or other output devices. The devices 118 may include various input devices such as scanners, digitizers, cameras, or other input devices. The devices 118 may include other peripheral devices such as instruments, controllers, computers, servers, network appliances, routers, switches, gateways, firewalls, other network equipment, or any other device that may be considered a resource by the client device 102. The private network 116 may include various resources such as servers 120 and file systems 122.

Each resource may have different mechanisms by which a client device 102 may determine the performance of the resource. For example, a specialized test query may be used for performance evaluation of an electronic instrument resource. In another example, a simple lightweight directory access protocol (LDAP) query may be used to evaluate the availability and, in some cases, performance of a directory service or server that provides access to a file system 122. A website 106 may be evaluated by sending a request for a webpage, in yet another example. In some cases, a device may have a self diagnostic or status command that may be queried to determine the device's recent performance characteristics.

The client device 102 may have several functional components that make up a resource monitor. A network connection 124 may be a connection to the Internet 104 or some other network through which communications to various resources may flow. In many cases, a network connection 124 may have several configuration parameters that may be adjusted to change the operational characteristics of the network connection 124. In many such cases, the network connection 124 may be adjusted in one manner for connecting to one resource while being adjusted in another way for connecting to another resource.

A data collection engine 126 may interact with the network connection 124 to test the availability of different resources.

In some embodiments, the data collection engine 126 may send out simple test queries at a relatively high frequency and may send out more complex test queries at a lower frequency. For example, the data collection engine 126 may make an initial query to a device by sending a remote procedure call that may exercise various functions of the resource every fifteen minutes while sending a ping command to the resource every 30 seconds. In such an example, the query that exercises various functions may be used to generate detailed performance data for the resource itself and the ping commands may verify that the resource is still available and may evaluate the network connection. The combination of the detailed query plus the more frequent ping command may be used by the data analyzer 128 to generate a summary statistic that may be shown on the display 130.

The data analyzer 128 may be a function that generates a summary statistic that may be used in a display 130 for a user. The summary statistic may be any type of information that may be displayed for a user. In some embodiments, a single red/yellow/green indicator may be generated for a service that is not working, working at a reduced performance level, or working at a normal performance level, respectively. In another embodiment, the summary statistic may be a network performance indicator as well as a separate performance indicator for the resource itself.

In some cases, a performance indicator may be a simplified visual indicator such as a multicolored icon, while in other cases, a numerical or text based indicator may be used. Some embodiments may use a numerical display to show latency times, data throughput, response times, or other statistic. Some embodiments may display two or more statistics for a given resource. In some embodiments, a single statistic may be used to aggregate two or more resources together. Such embodiments may be used when two resources may share a common element, such as when two resources are provided through a common server.

The display 130 may be any type of data output indicator for a user. In some cases, a resource monitor may be a tool or gadget in a set of sidebar applications. In other cases, a resource monitor may be an application or service that operates on a client device 102.

The data collection engine 126 may update a performance database 132 with the performance results of the resource. The performance results may be used by a connection optimizer 134 to evaluate different connection parameters and determine an optimized configuration for the resource. The connection optimizer 134 may optimize individual connections between the client device 102 and various resources.

The connection optimizer 134 may analyze and improve a connection to a resource in a simplified manner by taking a baseline measurement, adjusting a parameter or configuration setting, and taking a second measurement. By comparing the measurements as taken by the data collection engine 126, the connection optimizer 134 may find improved settings for each connection to a resource. In some embodiments, the connection optimizer 134 may employ sophisticated optimization techniques, including using various artificial intelligence mechanisms, complex logic trees, or other high heuristics to optimize a connection. In some embodiments, specific resources may have a set of heuristics that are specially adapted to a particular type of resource or may be further tailored for specific characteristics of the particular implementation of the resource.

In some embodiments, optimized settings may be determined for connections to each of the monitored resources. In some cases, two or more resources may be available through a single network connection, gateway, server, or some other common element. In some of such cases, different optimized settings may be determined for different services even though they have a common element.

In some cases, a connection optimizer 134 may be invoked automatically and in other cases, the connection optimizer 134 may be invoked manually. In some embodiments, a resource with no or poor availability may automatically invoke a connection optimizer 134 to troubleshoot the connection and attempt to restore a level of service. In some cases, the connection optimizer 134 may be automatically invoked when the client device 102 is not busy with other tasks and the connection optimizer 134 may periodically attempt to optimize connections during periods where processor time or network access is not used by other applications.

The connection optimizer 134 may be invoked by a user through the display 130. In some cases, a user may be able to select a single resource connection for optimization while in other cases, a user may be able to select a group or all of the connections for optimization. A user may be able to select various types of optimization. In a case where no connectivity exists, a user may invoke the connection optimizer 134 to perform remedial steps to attempt at least some connectivity. In a case where some connectivity exists, a user may invoke the connection optimizer 134 to perform various tweaks or performance optimization.

The user interface or display 130 may be used to define a set of resources to monitor. In some cases, a resource monitor may be installed with a default set of resources to monitor, and such a default set may be tailored for specific implementations. For example, a corporate administrator may define a set of monitored resources for an employee's laptop computer that define resources within a private network 116 owned by the employer. The user may be permitted to edit, modify, add, or delete monitored resources using the display 130 or another application or editor.

A configuration manager 136 may be used to store, retrieve, and apply a set of configuration settings. When a set of configuration settings is determined, the set may be stored in a configuration database 140 for later retrieval. In many cases where a client device may be portable and may connect to the Internet 104 from different locations, a location designator 138 may be stored with each set of configuration settings.

For a portable device, a user may find that some locations may use different optimal settings for various resources. For example, a laptop computer connected within a private network 116 may have very good connectivity to devices 118, servers 120, and file systems 122 within the private network. When the laptop computer is connected to the Internet 104 from an employee's home, a different set of configuration settings may be optimal. When the laptop computer is connected to the Internet 104 through a coffee shop connection in a distant country, a third set of configuration settings may be optimal.

In such an example, the client device 102 may be able to automatically determine the type of connection and select an appropriate set of configuration settings. In some cases, a user may be able to select from a group of locations for an appropriate set of configuration settings.

The designator for a location 138 may be any type of input parameter. In some cases, a user may be prompted to type a location, while in other cases, the client device 102 may be able to determine a location through the type of network connection, a network address of the connection, querying a server or host on a local area network or access point, a geopositional locator such as a Global Positioning System (GPS) receiver, or some other input.

Some embodiments may incorporate one or more different feedback loops that may use the performance database 132 and the configuration database 140 for various purposes. In one feedback loop, the client device 102 may notify a user or an administrator of problems with one or more connections to a resource. The user may be notified through the display 130 or through an email or other alert. An administrator may be notified through email or other messaging mechanism.

In some embodiments, an administrator may be able to access the performance database 132 and the configuration database 140 for various reporting, auditing, and other analysis. Some embodiments may have a mechanism by which many clients may supply a performance database 132 and/or a configuration database 140. An administrator may be able to analyze a database aggregated from multiple clients for various purposes.

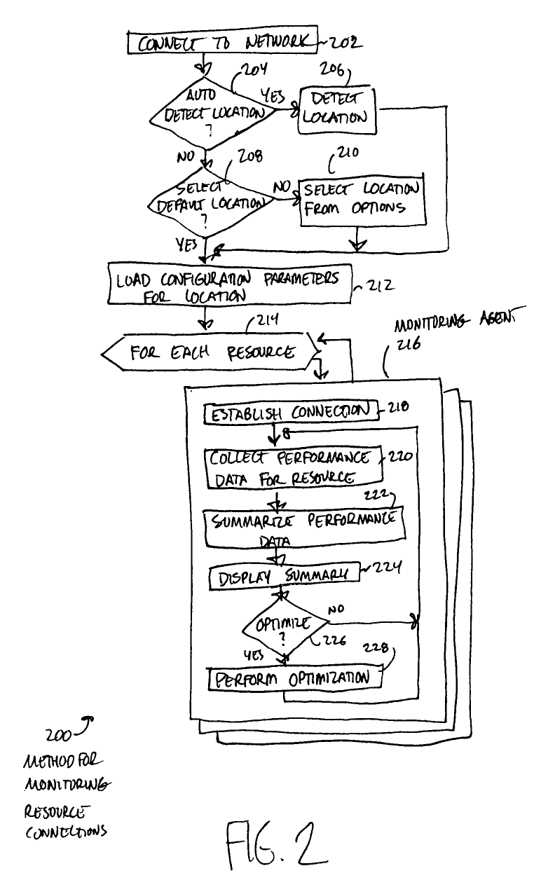

FIG. 2 is a flowchart illustration of an embodiment 200 of a method for monitoring resource connections. Embodiment 200 is a simplified example of a method for determining a set of configuration settings based on location and monitoring each monitored resource. Other embodiments may use different terminology or nomenclature and may include additional steps or may combine two or more steps into a single step. In other embodiments, some steps illustrated as serial may be performed in parallel and vice versa.

Embodiment 200 illustrates a method whereby a set of configuration settings may be selected based on a location, and whereby each resource may be monitored. Some embodiments may store sets of configuration settings that may be stored for different locations or different situations. A set may be automatically or manually selected.

A connection may be made to a network in block 202. In a typical embodiment, a device may connect to a network and negotiate with a server device to establish network connectivity. In some cases, a connection may be a hardwired connection where an Ethernet or other protocol is used to connect to a network. In other cases, a wireless connection may be established. In many cases, a connection may be made to a local area network, access point, or other device that may give further access to the Internet.

If a client device is capable of automatic location detection in block 204, the location may be detected in block 206. Automatic location detection may be any mechanism by which a client device may determine a location so that a corresponding set of configuration parameters may be selected.

A client device may be able to automatically determine a location using several different mechanisms. A client device may be able to determine a location through a connection to a network or through other mechanisms. For example, a client device may connect to a network and be assigned a network address from a server on the network. From the network address, a corresponding set of configuration parameters may be determined.

In the example, a client device may connect to a private corporate network and be assigned a network address from a range of network addresses. By determining that the assigned network address is within the range of network addresses administered by the corporation, the location of the client device may be resolved as being within the corporate network. In such a case, the set of configuration parameters associated with the corporate network may be selected. The same client device may be capable of connecting to a wireless service accessed in an airport or coffee shop, determining that the location is outside of the corporate network, and applying a different set of configuration parameters.

In some cases, a client device may determine a geographic position through various mechanisms. For example, a device may have a Global Positioning System (GPS) receiver that may be used to determine its geographic position. In some cases, a device may be able to determine a geographical location by receiving wireless transmissions, such as cellular phone signals or other broadcast signals to resolve a position.

If auto detection is not capable, not enabled, or not successful in block 204, a default location may be selected in block 208. If the default location is not selected in block 208, a user may manually select a location from a set of predefined locations in block 210.

Each embodiment may use different logic, different sequences, and various user interfaces to determine a location and select a set of configuration parameters. Some embodiments, such as devices that may not be used in a mobile fashion, may have a single set of configuration parameters.

After a location is determined, a set of configuration parameters corresponding to the location may be loaded in block 212. The configuration parameters may be any setting, variable, or other mechanism that may be adjusted to enable connectivity with a resource and modify the performance of the resource for a client device. In many embodiments, each monitored resource may have different configuration parameters even when two or more monitored resources may share some or all of a network connection. For example, two monitored resources may be services provided on a single server, and each service may have different configuration parameters defined.

For each resource on block 214, a monitoring agent 216 may be launched. Each embodiment may have different architectures for monitoring various resources. In some embodiments, as in embodiment 200, several independent monitoring agents may be launched to monitor and optimize a connection to a resource. In other embodiments, a data collection engine may poll each resource in succession to collect performance data, update a status display, and perform any optimization. The embodiment 200 has been selected to illustrate the functional elements of an embodiment, the precise architecture and design of a resource monitor may be varied based on the type of client, type of resources that may be monitored, and the desired level of functionality of a particular embodiment.

The monitoring agent 216 may establish a connection to a resource in block 218.

Performance data may be collected for the resource in block 220. In many cases, performance data may be collected for some level of functionality of the resource in addition to performance data for a network connection to the resource. Functionality performance data may range from a simple binary indicator such as whether or not a resource is operational.

An example of such binary performance data may be determined by a ping command. From a ping command, a client device may be able to determine that a resource exists, the resource is reachable through a network connection, and that the resource has at least a basic functionality. In many cases, a binary indicator of functionality may be sufficient to monitor a resource.

In some cases, performance data for a resource may include statistics about the performance aspects of the resource. For example, a database application may be queried to determine an average response time or a server device may be queried to determine a processor or memory load factor. In another example, a printer or other output device may be queried to determine the length of a queue for pending jobs.

Each monitored resource or type of monitored resource may have a different mechanism for determining performance information about the monitored resource. A ping command may be used for basic information on many types of resources, while an LDAP query may be performed against directory service, a database query against a database application, or a remote procedure call performed against a remotely hosted service. In some cases, a specialized query may be created for a monitored resource.

Performance data may also include performance of a network connection between a client device and the monitored resource. In the example of a ping command, a round trip travel time for a communication may be provided. The travel time may give some indication about the network load and the speed of an interaction with the resource. Some embodiments may have more detailed queries that may provide statistics on available bandwidth, packet routing paths, or other parameters relating to the network connection.

The performance data may be summarized in block 222 and displayed in block 224. In many embodiments, a general health indicator may be generated that gives a simple rating that can give a user a quick visual indicator if a problem exists. For example, a red/yellow/green indicator may be used to summarize one or more performance parameters for a given monitored resource. In some embodiments, a numerical rating or numerical statistic may be generated to summarize the quality of service for a particular monitored resource.

If the connection to the monitored resource is to be optimized in block 226, an optimization may be performed in block 228. Otherwise, the process may return to block 220.

In some embodiments, an automatic optimization may be performed in certain situations. For example, if no connectivity is detected or if performance is very poor, an optimization routine may be performed to restore at least partial operation of a resource. In some cases, automatic optimization may be performed as a background process when a client device is not busy. Some embodiments may have a user initiated optimization where a user may select one, some, or all of the monitored resources for optimization.

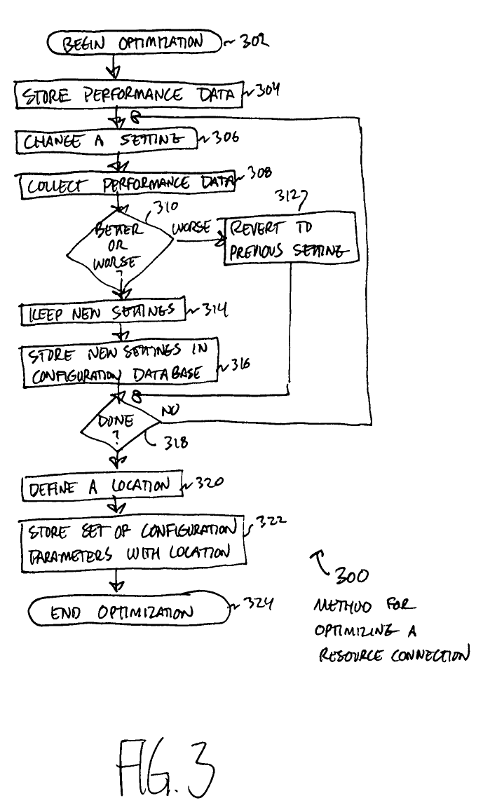

FIG. 3 is a flowchart illustration of an embodiment 300 showing a method for optimizing a resource connection. Embodiment 300 is a simplified example of an optimization routine, and was selected to illustrate some functional elements of a typical embodiment. Other embodiments may use different terminology or nomenclature and may include additional steps or may combine two or more steps into a single step. In other embodiments, some steps illustrated as serial may be performed in parallel and vice versa.

Embodiment 300 illustrates a method whereby a connection to a resource may be optimized using performance data as a feedback loop to determine if an attempted change is improving a connection. The connection settings may be stored in a configuration database with a location designation for later recall.

The optimization method may begin in block 302. The optimization method of embodiment 300 may be the optimization of block 228 in embodiment 200. In embodiment 200, a set of performance data is collected in block 220 prior to the optimization of block 228. Such performance data may be stored in block 304.

A setting may be changed or modified in block 306, and another set of performance data may be collected in block 308. If the new performance data is worse in block 310, the previous settings may be used in block 312. If the new performance data is better in block 310, the new settings may be retained in block 314 and stored in a configuration database in block 316. If more optimization is to be performed in block 318, the process may continue in block 306.

The optimization method of embodiment 300 may have a feedback loop that uses performance data as a factor in selecting if a change has improved the performance of a monitored resource. The performance data may be a combination of network connection performance and performance of the resource itself.

In some cases, a client device may be able to change various network connection parameters but not change parameters that may affect the actions taken by the resource. For example, a client device may be connected through the Internet to a general website. The client device may not be able to control the response time or performance of the website by modifying an HTML request, but the client device may be able to change various network configuration settings so that data may be transmitted and received faster through the network connection.

In another example, a printer device may be attached to a private network and available through a virtual private network connection when a client device is connected to the Internet. A client device may be able to change various connection parameters that may change the connectivity and throughput of the network connection, and may also be able to change the priority settings, paper settings, or other settings relating to jobs that the client sends to the printer device.

The optimization method of embodiment 300 may use many different techniques for determining which settings are available to change and how to change those settings. In some embodiments, complex heuristics may be developed for optimizing connection settings. Such heuristics may be embodied in logic trees, artificial intelligence mechanisms, predefined diagnostic and optimization routines, or other mechanisms.

Some embodiments may have a general purpose optimization routine that may evaluate several different TCP/IP settings, different Internet connection schemes, or other predefined sets of settings. Each set of settings may be tested and, using the performance data as a criterion, one set of settings may be selected. Such a general purpose routine may be used for gross changes to a connection to establish a baseline for connectivity performance. Some embodiments may have a further refinement of a connection wherein a set of variables may be slightly changed independently or as a group to further refine a resource performance.

Some monitored resources may be optimized using an optimization logic that is tailored to the specific type of monitored resource, and some may be tailored to a particular embodiment. For example, an optimization routine may be developed for file system resources. Such an optimization routine may optimize a file system resource for optimum performance based on the characteristics of file systems in general or may be tailored for optimizing a specific instance of a file system. In such an example, a corporate Information Technologies administrator may provide a specialized optimization routine to employee client devices so that connections to a private corporate file system are optimized.

As parameters are optimized and settings improved for better performance, the settings along with a location definition may be stored for later retrieval. A location may be defined in block 320 and the set of configuration parameters may be stored along with the location in block 322. The optimization sequence may end in block 324.

The location definition of block 320 may be any designator that may be used to later recall the set of configuration parameters. In some embodiments, such as portable clients, configuration settings may be different based on the physical location or network location of a client device. A connection through a wireless access point at an airport may have significantly different settings than a hardwired connection at a corporate office for an employee laptop computer, for example.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
collecting performance data between a client device and a plurality of remote services, said remote services being application layer services;
for each of said plurality of remote services, performing a method comprising:
storing said performance data;
changing at least one communication variable from a first value to a second value;
determining if said first value or said second value resulted in better performance to determine a preferred value; and
saving said preferred value;
determining a summarized status for each of said remote services; and
displaying at least a portion of said summarized status.

2. The method of claim 1 further comprising:
defining a set of optimized connection settings, said set of optimized connection settings being individual settings associated with each of said plurality of remote services; and
storing said set of optimized connection settings.

3. The method of claim 2 further comprising:
defining a location for said set of optimized connection settings; and
storing said location with said set of optimized connection settings.

4. The method of claim 3 further comprising:
storing a first of said set of optimized connection settings for a first location; and
storing a second of said set of optimized connection settings for a second location.

5. The method of claim 4 further comprising:
determining a current location;
selecting one of said sets of optimized connection settings corresponding to said current location; and
operate said plurality of remote services using said one of said sets of optimized connection settings.

6. The method of claim 5, said current location being determined at least in part by a network address.

7. The method of claim 1, said collecting performance data comprising executing a ping command to one of said remote services.

8. The method of claim 1, said collecting performance data comprising executing an LDAP query to one of said remote services.

9. A computer readable medium comprising computer executable instructions adapted to perform the method of claim 1.

10. A device comprising:
a data collection engine having a connection test mechanism adapted to transmit a communication to a remote service, receive a communication from said remote service, and determine at least one performance parameter for a connection to said remote service;
a data analyzer adapted to summarize said at least one performance parameter into a summary parameter; and
a display adapted to show at least one of said summary parameters.

11. The device of claim 10 further comprising:
a connection optimizer adapted to perform at least one optimization of said connection to said remote service to determine an optimized setting for said connection to a remote service.

12. The device of claim 11 further comprising:
a configuration manager adapted to store said set of configuration parameters for each of said remote services.

13. The device of claim 12 further comprising:
a location identifier adapted to determine a location for said device;
said configuration manager further adapted to store said location with said set of configuration parameters.

14. The device of claim 13, said location being a network location.

15. The device of claim 13, said location being a geographical location.

16. The device of claim 13, said configuration manager further adapted to:
store a first set of configuration parameters for a first location; and
store a second set of configuration parameters for a second location.

17. The device of claim 16, said configuration manager further adapted to:
receive a location designator;
retrieve one of a plurality of sets of configuration parameters corresponding to said location designator; and
operate said remote service using said one of a plurality of sets of configuration parameters.

18. The device of claim 17, said location designator being determined at least in part by a network address.

19. The device of claim 10, at least one of said performance parameters being determined as a result of a ping command.

20. The device of claim 10, at least one of said performance parameters being determined as a result of an LDAP query.
